(19) United States
(12) Patent Application Publication
(10) Pub. No.: US 2014/0335293 A1
(43) Pub. Date: Nov. 13, 2014

(54) Multiple Layer Film Capable of Linear Tear Propagation

(71) Applicants: Michael Schuhmann, Grosshabersdorf (DE); Henrik Hummel, Leipzig (DE); Roland Kelm, Forchheim-Kersbach (DE)

(72) Inventors: Michael Schuhmann, Grosshabersdorf (DE); Henrik Hummel, Leipzig (DE); Roland Kelm, Forchheim-Kersbach (DE)

(73) Assignee: Huhtamaki Films Germany GmbH & Co. KG, Forchheim (DE)

(21) Appl. No.: 14/240,268

(22) PCT Filed: Aug. 15, 2012
(86) PCT No.: PCT/EP2012/003467

§ 371 Date: Jun. 16, 2014

(30) Foreign Application Priority Data
Aug. 23, 2011 (DE) 10 2011 110 839.8
Dec. 15, 2011 (DE) 10 2011 121 143.1

(51) Int. Cl. B32B 27/32; B32B 27/08; B32B 7/06; B32B 7/02; B32B 1/02

(52) U.S. Cl. CPC B32B 27/32; B32B 7/02; B32B 1/02; B32B 7/06; B32B 27/08; B32B 2250/03; B32B 2250/04; B32B 2250/242; B32B 2307/582; B32B 2323/046; B32B 2439/00
USPC 428/35.2; 428/216; 428/195.1; 428/172; 428/35.7

(57) ABSTRACT

A multilayer film is provided, including a layer sequence of a layer (a) of at least one low density polyethylene (LDPE) having a density in the range 0.915-0.930 g/cm³ or a mixture of LDPE with at least one other acyclic C₂-C₆ olefin polymer or copolymer, a layer (b) of a mixture of at least one low density polyethylene (LDPE) having a density in the range 0.915-0.930 g/cm³ and at least one cyclic olefin copolymer, and a layer (c) of at least one low density polyethylene having a density in the range 0.915-0.930 g/cm³ or a mixture of LDPE with at least one other acyclic C₂-C₆ olefin polymer or copolymer, such that the film's tear propagation force in both the machine direction and transverse to the machine direction is at most 1000 mN, per the Elmendorf test (per DIN EN ISO 6383-2).

This application is a continuation of PCT International Application No. PCT/EP2012/003467, filed Aug. 15, 2012, which claims priority under 35 U.S.C. §119 from German Patent Application No. 10 2011 110 839.8, filed Aug. 23, 2011, and German Patent Application No. 10 2011 121 143.1, filed Dec. 15, 2011, the entire disclosures of which are herein expressly incorporated by reference.

### BACKGROUND AND SUMMARY OF THE INVENTION

The present invention relates to a multilayer film comprising a layer sequence made of a layer (a) based on at least one low-density polyethylene (LDPE) with a density in the range from 0.915 to 0.930 g/cm³ or a mixture of (a) at least one low-density polyethylene (LDPE) with a density in the range from 0.915 to 0.930 g/cm³ and of ((3) at least one non-cyclic C₂ C₆ olefin homo or copolymer which differs from polyethylene component (a), a layer (b) based on a mixture of at least one low-density polyethylene (LDPE) with a density in the range from 0.915 to 0.930 g/cm³ and at least one cycloolefin copolymer, and a layer (c) based on at least one low-density polyethylene (LDPE) with a density in the range from 0.915 to 0.930 g/cm³ or a mixture of (a) at least one relatively low-density polyethylene (LDPE) with a density in the range from 0.915 to 0.930 g/cm³ and of ((3) at least one non-cyclic C₂ C₆ olefin homo or copolymer which differs from polyethylene component (a), characterized in that the tear propagation force for the multilayer film both in machine direction and perpendicularly to the machine direction is at most 1000 mN when the total thickness of the multilayer film is 60 μm.

The prior art, e.g. GB 2 397 065 A, has already disclosed multilayer films capable of linear tear propagation which are suitable for the production of packaging. The tear propagation force of said multilayer films in machine direction is low, while the tear propagation force perpendicularly to the machine direction is markedly higher.

A factor restricting the processing of multilayer films of that type to produce packaging is that the lower tear propagation force predetermines the direction of tear to open packaging produced from that type of multilayer film, and thus predetermines the manner of further processing of the film to give the packaging.

Furthermore, the known multilayer films capable of linear tear often have unsuitable mechanical properties, for example excessively low puncture resistance or unsatisfactory behavior in relation to tear and to tear propagation.

However, in particular multilayer films in the form of material for packaging, e.g. single-use packaging, should exhibit maximum progressive linear behavior in relation to tear and to tear propagation, in order to avoid uncontrolled tear during opening and any resultant inappropriate access to the packaged product.

Maximum puncture resistance of the packaging material is moreover advantageous in order to facilitate handling of the packaging produced from the multilayer films. A particular reason for this is that the product packaged with the multilayer films is usually placed in mutually superposed layers or stacks during storage and transport, and unintended puncture of the packaging can occur here. This increases the number of rejected products.

There is therefore a need for multilayer films which feature very good behavior in relation to straight and linear tear propagation in longitudinal and transverse direction, and which also have very good puncture resistance.

It was therefore an object of the present invention to provide a multilayer film with improved mechanical properties such as low tear propagation force in longitudinal and transverse direction and improved puncture resistance, and also with a minimum deviation from straight, linear tear and, respectively, tear propagation.

This object is solved by the provision of the inventive multilayer film, comprising a layer sequence of

(a) a layer (a) based on at least one low-density polyethylene (LDPE) with a density in the range from 0.915 to 0.930 g/cm³ or a mixture of (α) at least one low-density polyethylene (LDPE) with a density in the range from 0.915 to 0.930 g/cm³ and of (β) at least one non-cyclic C₂ C₆ olefin homo or copolymer which differs from polyethylene component (α),

(b) a layer (b) based on a mixture of at least one low-density polyethylene (LDPE) with a density in the range from 0.915 to 0.930 g/cm³ and at least one cycloolefin copolymer, and

(c) a layer (c) based on at least one low-density polyethylene (LDPE) with a density in the range from 0.915 to 0.930 g/cm³ or a mixture of (α) at least one low-density polyethylene (LDPE) with a density in the range from 0.915 to 0.930 g/cm³ and of (β) at least one non-cyclic C₂ C₆ olefin homo or copolymer which differs from polyethylene component (α),

characterized in that the tear propagation force for the multilayer film both in machine direction and perpendicularly to the machine direction is at most 1000 mN, determined by the Elmendorf test in accordance with DIN EN ISO 6383 2, when the total thickness of the multilayer film is 60 μm.

For the purposes of the invention, the expression “layer sequence” means that the layers a), b), and c) are present in the sequence listed and are present directly adjacent to one another. Additional layers can optionally be present on a surface of the layer sequence.

For the purposes of the invention, the expression “low-density polyethylene” or “LDPE” means unfoamed low-density polyethylene with a high degree of branching of the molecules, i.e. the main polymethylene chain bears from 8 to 40 side chains made of repeating methylene units and comprises no polymerized units of other olefins.

For the purposes of the present invention, the expression “cycloolefin copolymer” or “COC” means an amorphous copolymer which is produced via copolymerization of cyclic (C₆ C₁₂)-olefin monomers, preferably norbornene or tetracyclododecene, with a (C₂ C₄)-olefin such as ethylene.

In the invention, the expression “machine direction” means the production direction in which the multilayer film is produced and optionally rolled up.

In the invention, the expression “based on” means “composed of”.

In one preferred embodiment, the tear propagation force for the multilayer film of the invention both in machine direction and perpendicularly to the machine direction is at most 800 mN, determined by the Elmendorf test in accordance with DIN EN ISO 6383-2, and when the total thickness of the film is 60 μm.

It is further preferably that the ratio of the tear propagation force in machine direction to the tear propagation force perpendicularly to the machine direction, determined by the Elmendorf test in accordance with DIN EN ISO 6383-2 for the inventive multilayer film, is from 2:1 to 1:2, preferably from 1.5:1 to 1:1.5.

The inventive multilayer film also features high puncture resistance, preferably of at least 50 N, particularly preferably at least 53 N, determined in accordance with ASTM E154-88 part 10.

In one preferred embodiment, the density of the polyethylene (LDPE) of each of the layers (a), (b), and (c) is in the range from 0.920 to 0.927 g/cm³.

It is preferable that the melting point of the polyethylene of each of the layers (a), (b), and (c), determined in accordance with DIN EN ISO 3146, is at most 118° C., particularly at most 116° C.

Both, the layer (a) and the layer (c), can, while being identical or different from one another, be composed of the following mixture as polymer components: a mixture (α) of at least one low-density polyethylene (LDPE) with a density in the range from 0.915 to 0.930 g/cm³, preferably from 0.920 to 0.927 g/cm³, and of (β) at least one non-cyclic C₂ C₆ olefin homo or copolymer which differs from the (α) polyethylene component and which is preferably an ethylene or propylene homo or copolymer, particularly preferably a polypropylene and/or ethylene/propylene copolymer.

It is preferable that the polymer mixture is composed of at least 50% by weight, particularly of at least 70% by weight to 95% by weight, based in each case on the total weight of the polymer mixture (α) and (β), of the polyethylene component (α).

It is preferable that at least one of the layers (a) and (c) is a surface layer of the inventive multilayer film and is heat-sealable.

The layers (a) and (c) can be identical or different, preferably being identical.

The thickness of the layer (a), respectively of the layer (c) of the inventive multilayer film is preferably from 5 μm to 75 μm, particularly from 10 μm to 50 μm, in particular from 15 μm to 25 μm.

In one preferred embodiment of the inventive multilayer film the layer (a) and the layer (c) have an identical layer structure, and preferably an identical thickness, and/or an identical composition of the polymer component(s).

The layer (b) of the multilayer film of the invention is based on a mixture of at least one low-density polyethylene (LDPE) with a density in the range from 0.915 to 0.930 g/cm³, preferably from 0.920 to 0.927 g/cm³, and at least one cycloolefin copolymer.

In one preferred embodiment, the cycloolefin copolymer is a copolymer of at least one (C₆ C₁₂)-cycloolefin and one non-cyclic (C₂ C₄)-olefin, preferably a norbornene/ethylene copolymer or a tetracyclo [symbol] dodecene/ethylene copolymer, particularly preferably a norbornene/ethylene copolymer.

In one preferred embodiment, the glass transition temperature T_{g} of the cycloolefin copolymer, determined in accordance with ISO 11357 1, 2, 3 (DSC), is at least 60° C., preferably at least 80° C., and very particularly preferably at least 100° C.

It is preferably that the amount of the cycloolefin of the cycloolefin copolymer is at least 50% by weight, particularly at least 70% by weight, based on the total weight of the cycloolefin copolymer.

In one particular embodiment, the amount of the cycloolefin copolymer component of the layer (b) is at most 50% by weight, preferably at most 40% by weight, and particularly preferably from 20 to 35% by weight, based on the total weight of polymer components.

It is preferably that the thickness of the layer (b) is from 5 μm to 100 μm, particularly from 10 μm to 50 μm, very particularly from 15 μm to 30 μm.

It is preferably that the thickness of the layer (b) is at least 20%, particularly from 25 to 75%, based on the total thickness of the layer sequence (a) (c).

It is preferably that the total thickness of the layer sequence (a) (c) is at least 30%, particularly from 50% to 100%, based on the total thickness of the inventive multilayer film.

The inventive multilayer film can be produced by any known production processes, e.g. lamination, extrusion, preferably coextrusion, particularly preferably blown-film coextrusion.

According to another embodiment, the inventive multilayer film can be produced by producing its individual layers, a partial composite of its layers, or the whole multilayer film in form of a tubular film and then be processed.

In another preferred embodiment, at least the layer sequence (a) (c) is produced in the form of a preferably coextruded tubular film.

The blow-up ratio of the coextruded layer sequence (a) (c) can preferably be at least 1:1, particularly preferably at least 1.5:1, very particularly preferably at least 2:1.

In another embodiment, the multilayer film can also be produced in the form of laminate comprising the coextruded layer sequence (a) (c) and optionally at least one further layer.

A further layer present can be a barrier layer (d) and/or a layer (e) based on at least one thermoplastic polymer as substrate layer, whereby the barrier layer is optionally connected by way of an adhesion-promoter layer to the other layers of the film composite.

In another preferred embodiment, the entire multilayer film has the form of a preferably coextruded tubular film, which can be optionally processed to a flat laid film.

The form in which the inventive multilayer film is produced is particularly preferably that of a multilayer blown film, preferably produced via extrusion, in particular via blown-film coextrusion.

In another embodiment, the form in which the multilayer film can be produced and processed is to some extent or entirely that of a cast film.

It is preferably that the multilayer film produced in the form of cast film has been stretched at least monoaxially with a stretching ratio of at least 1:1.5, particularly at least 1:2, particularly preferably from 1:2 to 1:4.

In one preferred embodiment, the multilayer film produced in the form of cast film has been stretched monoaxially in longitudinal direction with a stretching ratio of from 1:1.5 to 1:10, particularly preferably from 1:2 to 1:4.

In another preferred embodiment, the multilayer film produced in the form of cast film is orientated biaxially with a ratio of longitudinal to transverse stretching of preferably at least 1:1, particularly preferably at least 1.1:1, and very particularly preferably at least 1.2:1.

As stated before, individual layers, or all of the layers, of the inventive multilayer film can be produced by (co)extrusion, preferably in the form of flat film extrudates (=cast films) or optionally in the form of multilayer tubular films. The extruded films can be stretched to the necessary extent during production or preferably immediately after extrusion.

If individual layers of the inventive multilayer film are produced separately by one of the above processes, or if individual layers have inadequate adhesion within the composite, it can be necessary that the structure of the multilayer film also comprises an adhesion-promoter layer. This can by way of example be applied in the form of melt or in the form of a liquid preparation, for example in the form of solution or dispersion, by usual methods, such as spraying or casting, onto one of the layers that needs adhesion in the inventive multilayer film, for example onto the layer (c), in order to be connected with the other layers. Alternatively, it is also optionally possible to apply the adhesion-promoter layer to the layer (c) by extrusion in order to bond it directly to another layer, such as a barrier layer, or to a layer composite.

As already stated, the multilayer film of the invention can comprise further layers besides the layer sequence (a) (c). These layers can be coextruded with the layer sequence (a) (c) or laminated onto the layer sequence (a) (c), as appropriate for the kind of the further layers.

The multilayer film of the invention can therefore comprise a barrier layer (d) besides the layer sequence (a) (c).

This barrier layer (d) preferably serves as gas-barrier layer, particular preference being given to an oxygen-barrier layer and/or a water-vapor-barrier layer.

The barrier layer (d) can preferably be based on at least one ethylene-vinyl alcohol copolymer, on at least one polyvinyl alcohol, on at least one metal, preferably aluminum, or on at least one metal oxide, preferably SiOx or aluminum oxide, and this metal can be in form of foil or, like a metal oxide, applied from the vapor phase.

The barrier layer (d) can be based on an ethylene-vinyl alcohol copolymer (EVOH) which has been obtained by an essentially complete hydrolysis of a corresponding, ethylene-/vinyl acetate copolymer (EVAc). The degree of hydrolysis of said fully hydrolyzed ethylene-/vinyl acetate copolymer is ≧98%, and the amount of ethylene is from 0.01 to 80 mol %, preferably from 1 to 50 mol % of the copolymer.

The barrier layer (d) can also be based on a polyvinyl alcohol which has been obtained via, essentially, complete hydrolysis of a polyvinyl acetate (PVA), and which in the form of fully hydrolyzed polyvinyl acetate has a degree of hydrolysis of ≧98%.

To the extent that a metal has been used as barrier layer (d), this is preferably aluminum applied from the vapor phase.

The thickness of the barrier layer (d) is preferably from 1 μm to 100 μm, with preference from 2 μm to 80 μm, with particular preference from 3 μm to 60 μm, with very particular preference from 4 μm to 40 μm; the layer thickness of a metal oxide or metal applied from the vapor phase is however only in the A range.

The inventive multilayer film can optionally comprise, besides the layer sequence (a) (c) and any barrier layer (d) present, a layer (e) based on at least one thermoplastic polymer, as substrate layer.

Materials suitable for the production of the layer (e) are preferably thermoplastic polymers selected from the group comprising polyolefins, polyamides, polyesters, polystyrenes, and copolymers of at least two monomers from the polymers mentioned, particularly preferably olefin homo or copolymers and/or polyesters.

The inventive multilayer film can optionally have, on at least one of its surfaces, a release layer preferably based on at least one polysiloxane, preferably when the inventive multilayer film is not used as packaging material.

The inventive multilayer film can optionally also have, on both surfaces, a release layer preferably based on at least one polysiloxane, when the multilayer film is not used as packaging material.

For the purposes of the present invention, the expression “polysiloxane” means compounds having polymer chains composed of alternating atoms of silicon and of oxygen. A polysiloxane is based on n repeating siloxane units (—[Si(R2)O]—)ₙ which in each case mutually independently have disubstitution by two organic moieties R, where R is preferably in each case R¹ or OR¹, and R¹ is in each case an alkyl moiety or an aryl moiety.

It is preferable that the hardened polysiloxane is based on a repeating dialkylsiloxane unit or on a repeating alkylarylsiloxane unit. The number of Si O bonds possessed by an individual siloxane unit, in each case based on a tetravalent silicon atom, can be used to divide said units into terminal monofunctional siloxanes (M) having one Si O bond, difunctional siloxanes (D) having two Si O bonds, trifunctional siloxanes (T) having three Si O bonds, and tetrafunctional siloxanes (Q) having four Si O bonds. The polysiloxane used in the invention preferably has a crosslinked ring or chain-type structure, particularly preferably a crosslinked chain-type structure, linked via (D), (T), and/or (Q) units to give a two or three-dimensional network. The number n of repeating siloxane units (—[Si(R2)-O]—)ₙ in the polysiloxane chain is termed the degree of polymerization of the polysiloxane.

The optionally present release layer is preferably based on at least one hardened, i.e. crosslinked polysiloxane selected from the group comprising addition-crosslinked, preferably metal-catalyzed addition-crosslinked, condensation-crosslinked, free-radical-crosslinked, cationically crosslinked, and/or moisture-crosslinked polysiloxanes.

It is preferable that the release layer is based on at least one hardened polysiloxane which has been hardened via thermal hardening, via hardening by electromagnetic radiation, preferably via UV radiation, or via exposure to moisture. It is preferable that the release layer of the multilayer film of the invention is based on at least one hardened polysiloxane selected from the group consisting of polydialkylsiloxanes, preferably polydimethylsiloxanes, and polyalkylarylsiloxanes, preferably polymethylphenylsiloxanes, hardened via UV radiation.

The thickness of the optionally present release layer of the inventive multilayer film is preferably from 0.1 μm to ≦3 μm, preferably from 0.2 μm to 1.5 μm.

The layer (a), the layer (b), the layer (c), and also the optionally present barrier layer (d) and substrate layer (e), and the optionally present adhesion-promoter layers made of the mentioned polymer components can, if necessary, in each case mutually independently comprise additives selected from the group consisting of antioxidants, antiblocking agents, antifogging agents, antistatic agents, antimicrobial ingredients, light stabilizers, UV absorbers, UV filters, dyes, color pigments, stabilizers, preferably heat stabilizers, process stabilizers, and UV and/or light stabilizers, preferably based on at least one sterically hindered amine (HALS), processing aids, flame retardants, nucleating agents, crystallization agents, preferably crystal-nucleating agents, lubricants, optical brighteners, flexibilizing agents, sealing agents, plasticizers, silanes, spacers, fillers, peel additives, waxes, wetting agents, surface-active compounds, preferably surfactants, and dispersing agents.

Care has to be taken that the addition of additives or the amount of these does not impair the tear propagation behavior of the multilayer film of the invention.

The layer (a), the layer (b), the layer (c), and also the optionally present layers (d) and (e), and the optionally present adhesive-promoter layers can, in each case mutually independently, comprise at least 0.01 30% by weight, preferably at least 0.1 20% by weight, based in each case on the total weight of an individual layer, of at least one of the abovementioned additives. The form in which the additives are incorporated for this purpose into the respective layer can be that of a masterbatch in polyolefins or olefin copolymers.

The multilayer film of the invention can have been printed, and/or colored, and/or embossed.

The multilayer film of the invention can optionally have been coated, on at least one of its surfaces, optionally only to some extent, with an adhesive layer.

Examples of suitable adhesives for the adhesive layer are pressure-sensitive adhesives based on acrylates, on natural rubbers, or on styrene-isoprene-styrene block copolymers, and silicone-based adhesives, e.g. polydimethylsiloxane and polymethylphenylsiloxane.

The inventive multilayer film is preferably suitable as packaging material.

The invention therefore further provides the use of an inventive multilayer film as packaging material.

The invention therefore further provides the use of an inventive multilayer film for the production of a packaging element.

The inventive multilayer film is in particular suitable for the production of a packaging element and/or of packaging, preferably of bag packaging, of a single-portion packaging, of a sachet, or of a stickpack.

The invention therefore further provides the use of an inventive multilayer film for the production of packaging, preferably of bag packaging, of a single-portion packaging, of a sachet, or of a stickpack.

The invention therefore further provides packaging in the form of bag packaging, of a single-portion packaging, of a sachet, or of a stickpack made of an inventive multilayer film.

The inventive multilayer film is preferably used for the production of easy-to-open packaging.

The invention therefore further provides easy-to-open packaging made of an inventive multilayer film. The packaged product can be removed without difficulty from packaging of this type, since tearing to open the packaging and tear propagation thereafter leads to a straight, linear tear. The risk of spillage or scattering of the packaged product is thus minimized.

The multilayer film of the invention is preferably suitable for the production of an easy-to-open packaging element, e.g. in the form of a lid of two-part packaging. This type of two-part packaging of the invention comprises the lid made of an inventive multilayer film and a container, which preferably has been designed as tray made of thermoformed plastic.

The invention therefore further provides an easy-to-open packaging element, preferably a lid, made of the inventive multilayer film.

A feature of the inventive packaging is that it exhibits easy and straight, linear tear propagation independently of the direction of production of the inventive multilayer film is used, i.e. both in machine direction and also perpendicularly thereto, and is therefore easy to open. A notch or a point of weakening can optionally be applied in order to assist tearing to open the inventive packaging. If a notch or a point of weakening is applied, this should preferably be present in the region of the seal seam in the direction of tear for opening.

Another feature of the inventive packaging is that it has high puncture resistance, and is therefore easier to handle, i.e. in comparison with films with similar tear propagation behavior it is less susceptible to damage caused by exposure to impacts during storage, transport, and sale.

In another preferred embodiment, an inventive multilayer film is also suitable as release film.

The invention therefore further provides the use of an inventive multilayer film as release film, in particular with a release layer as surface layer.

Since one of the important factors during the use of a release film, optionally together with the protected substrate, is that it can be separated at the desired length easily and along a straight, linear tear, the inventive multilayer film is particularly suitable as release film and protective film because the inventive film provides such separation and tearing propagation.

In this type of embodiment, the multilayer film of the invention can be used as protective and release film for adhesive tapes.

The invention therefore further provides the use of an inventive multilayer film as protective and release film for adhesive tapes.

Determination of Tear Propagation Resistance

The tear propagation force (tear propagation resistance) in machine direction (MD) and perpendicularly to the machine direction (CD) is determined for the inventive multilayer film in each direction by using the Elmendorf method in accordance with ISO 6383-2, with a total film thickness of 60 μm, and is stated in [mN].

Determination of Puncture Resistance

The puncture resistance of the inventive multilayer film is determined in accordance with ASTM E154-88 part 10, and is stated in [N].

Determination of any Deviation from a Straight, Linear Tear Propagation

The deviation of the inventive multilayer film from a straight, linear tear propagation is assessed by measuring any deviation from a straight, linear line during tearing (tear propagation). This is stated in [mm].

From each inventive multilayer film of which any deviation of the tear propagation is to be determined, 10 samples are cut in such a way that their length is 100 mm parallel to the machine direction (MD) and their width is 50 mm perpendicularly to the machine direction (CD). 10 samples are also cut in such a way that their length is 100 mm perpendicularly to the machine direction (CD) and their width is 50 mm parallel to the machine direction (MD).

A 50 mm incision, in the machine direction and parallel to the longitudinal side, is made in the middle of the width side of each of the individual samples, and underneath the incision each sample is provided, centrally and parallel to the longitudinal side, with a double-sided adhesive tape of width 20 mm and of length 90 mm. A marker is used to mark a linear extrapolation line from the incision, and this line serves as straight, linear tear line for measuring the deviation.

The tear propagation of the individual samples is determined under standard conditions of temperature and humidity (DIN 50014-23/50-2). To this end, the double-sided adhesive tape adhering to the material is used to fix one side of each of the individual samples at a defined angle of 45° [0] on a metal plate of width 100 mm and of length 350 mm.

The metal plate is clamped into the lower clamp of an electronic tear tester (Zwick). A double-sided adhesive tape is used to fix the incision end of the free side (“the free trouser leg”) of the individual samples on a stiff strip of film of length 400 mm, and this is clamped into the upper clamp of the tear tester.

The two sides of the individual samples are now pulled apart at an angle of 175° and with a velocity of 500 mm/min until the sample is completely separated.

The linear tear propagation of each samples is assessed by determining the maximal deviation A of the tear in mm from the marking line (straight, linear tear extrapolating the incision) at the end of the tear.

The average value is calculated from the maximal deviations A measured for the 10 samples with the dimensions 100 mm (MD)×50 mm (CD). This serves for assessment of linear tear propagation in machine direction (MD).

Correspondingly, the average value is likewise calculated from the maximal deviations A measured for the 10 samples with the dimensions 100 mm (CD)×50 mm (MD). This serves for assessment of linear tear propagation perpendicularly to the machine direction (CD).

### DETAILED DESCRIPTION

The inventive examples and comparative examples below serve to illustrate the invention, but are not being interpreted as restrictive.

### I. Chemical Characterization of the Polymers Used

Lupolen 2420 F: LDPE from Basell; density (ISO 1183): 0.927 g/cm³; melting point (ISO 3146): 114° C.
Innovex LL 0209 AA: LLDPE from Ineos; comprises 1-butene as comonomer; density (ISO 1183): 0.920 g/cm³
Topas 6013 F-04: norbornene/ethylene copolymer from Ticona GmbH with glass transition temperature 138° C., viscosity number 60 ml/g, and norbornene content about 79% by weight

### II. Production of Inventive Multilayer Films and of Multilayer Comparative Films

The multilayer films of the comparative example (ce1) and of the inventive example (ie1) consists in each case of three layers and in each case have a total film thickness of 60 μm. The individual layers of the multilayer films ce1 and ie1 in each case are directly adjacent to one another in the sequence in which they are listed below. The thickness of each of the individual layers of the multilayer films ce1 and ie1 is 20 μm, and each of the multilayer films was produced by blown-film coextrusion. The blow-up ratio was in each case 2:1.

### III. Inventive Example and Comparative Example

All following % are % by weight.

### III.1 Inventive Example 1 (ie1)

Layer (a) (20 μm): 100% of Lupolen 2420 F

Layer (b) (20 μm): 70% of Lupolen 2420 F and 30% of Topas 6013 F-04

Layer (c) (20 μm): 100% of Lupolen 2420 F

### III.2 Comparative Example 1 (ce1)

Layer (a) (20 μm): 100% of Innovex LL 0209 AA

Layer (b) (20 μm): 70% of Innovex LL 0209 AA and 30% of Topas 6013 F-04

Layer (c) (20 μm): 100% of Innovex LL 0209 AA

### IV. Determination of Elmendorf Tear Resistance, of Puncture Resistance, and of Deviation from Straight, Linear Tear

Tear resistance (Elmendorf) in machine direction (MD) and perpendicularly to the machine direction (CD), and puncture resistance, and any deviation from straight, linear tear during tear propagation in machine direction (MD) and perpendicularly to the machine direction (CD) were determined for the multilayer film of the inventive example (ie1) and of the comparative example (ce1), in each case according to the method described before.

| | Tear propagation | | Puncture | Deviation A | |
|---|---|---|---|---|---|
| Inventive example/ | force [mN] | | resistance | [mm] | |
| comparative example | MD | CD | [N] | MD | CD |
| ce1 | 1550 | 1020 | 32 | 25 | 19.5 |
| ie1 | 400 | 450 | 55 | 1.5 | 4.5 |

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof

What is claimed is:

1. A multilayer film comprising a layer sequence of
(a) a layer (a) based on at least one low-density polyethylene (LDPE) with a density in the range from 0.915 to 0.930 g/cm³ or a mixture of (α) at least one low-density polyethylene (LDPE) with a density in the range from 0.915 to 0.930 g/cm³ and of (β) at least one non-cyclic C₂-C₆ olefin homo- or copolymer which differs from polyethylene component (α),
(b) a layer (b) based on a mixture of at least one low-density polyethylene (LDPE) with a density in the range from 0.915 to 0.930 g/cm³ and at least one cycloolefin copolymer, and
(c) a layer (c) based on at least one low-density polyethylene (LDPE) with a density in the range from 0.915 to 0.930 g/cm³ or a mixture of (α) at least one low-density polyethylene (LDPE) with a density in the range from 0.915 to 0.930 g/cm³ and of (β) at least one non-cyclic C₂-C₆ olefin homo- or copolymer which differs from polyethylene component (α),
characterized in that the tear propagation force of the multilayer film both in machine direction and perpendicularly to the machine direction is at most 1000 mN, determined by the Elmendorf test in accordance with DIN EN ISO 6383-2.

2. The multilayer film as claimed in claim 1, characterized in that the ratio of the tear propagation force in machine direction to the tear propagation force perpendicularly to the machine direction, determined by the Elmendorf test in accordance with DIN EN ISO 6383-2 for the multilayer film, is from 2:1 to 1:2, preferably from 1.5:1 to 1:1.5.

3. The multilayer film as claimed in claim 1 or 2, characterized in that the tear propagation force for the multilayer film both in machine direction and perpendicularly to the machine direction is at most 800 mN, determined by the Elmendorf test in accordance with DIN EN ISO 6383-2.

4. The multilayer film as claimed in any of claims 1-3, characterized in that the puncture resistance of the multilayer film is at least 50 N, determined in accordance with ASTM E154-88 part 10.

5. The multilayer film as claimed in any of claims 1-4, characterized in that the density of the polyethylene (LDPE) of each of the layers (a), (b), and (c) is in the range from 0.920 to 0.927 g/cm³.

6. The multilayer film as claimed in any of claims 1-4, characterized in that the layer (a) and, respectively, (c) is composed of a mixture of (α) at least one polyethylene with a density of from 0.920 to 0.927 g/cm³ and of (β) at least one polypropylene and/or propylene copolymer.

7. The multilayer film as claimed in any of claims 1-6, characterized in that the mixture of (α) and (β) comprises at least 50% by weight, preferably at least 70% by weight, based on the total weight of polymer components (α) and (β), of polyethylene component (α).

8. The multilayer film as claimed in any of claims 1-7, characterized in that the glass transition temperature T_{g} of the cycloolefin copolymer of the layer (b), determined in accordance with ISO 11357-1, -2, -3 (DSC), is at least 60° C., preferably at least 80° C., and very particularly preferably at least 100° C.

9. The multilayer film as claimed in any of claims 1-8, characterized in that the cycloolefin copolymer of the layer (b) is a (C₆-C₁₂)-cycloolefin-(C₂-C₄)-olefin copolymer, preferably a norbornene/ethylene copolymer.

10. The multilayer film as claimed in any of claims 1-9, characterized in that the proportion of the cycloolefin in the cycloolefin copolymer of the layer (b) is at least 50% by weight, particularly preferably at least 70% by weight, based on the total weight of the cycloolefin copolymer.

11. The multilayer film as claimed in any of claims 1-10, characterized in that the proportion of the cycloolefin copolymer component in the layer (b) is at most 50% by weight, preferably at most 40% by weight, and particularly preferably from 20 to 35% by weight, based on the total weight of polymer components of the layer (b).

12. The multilayer film as claimed in any of claims 1-11, characterized in that the thickness of the layer (b) is at least 20%, preferably from 25 to 75%, based on the total thickness of the layer sequence (a)-(c).

13. The multilayer film as claimed in any of claims 1-12, characterized in that the total thickness of the layer sequence (a)-(c) is at least 30%, preferably from 50% to 100%, based on the total thickness of the multilayer film.

14. The multilayer film as claimed in any of claims 1-13, characterized in that the layer sequence (a)-(c) has been produced in the form of a preferably coextruded tubular film.

15. The multilayer film as claimed in any of claims 1-14, characterized in that the entire multilayer film has the form of a preferably coextruded tubular film.

16. The multilayer film as claimed in claim 14 or 15, characterized in that the blow-up ratio of the coextruded layer sequence (a)-(c) or multilayer film is at least 1:1, preferably at least 1.5:1, particularly preferably at least 2:1.

17. The multilayer film as claimed in any of claims 1-13, characterized in that the multilayer film was produced as a cast film to some extent or entirely and processed.

18. The multilayer film as claimed in claim 17, characterized in that the multilayer film produced as cast film was orientated at least monoaxially with a orientation ratio of at least 1:1.5, preferably at least 1:2, particularly preferably from 1:2 to 1:4.

19. The multilayer film as claimed in claim 17, characterized in that the multilayer film produced as cast film was orientated biaxially with a ratio of longitudinal to transverse orientation of preferably at least 1:1, particularly preferably at least 1.1:1, and very particularly preferably at least 1.2:1.

20. The multilayer film as claimed in any of claims 1-14, characterized in that the multilayer film comprises, besides the layer sequence (a)-(c), at least one barrier layer (d), preferably based on at least one ethylene-vinyl alcohol copolymer, on at least one polyvinyl alcohol, on at least one metal, preferably aluminum, or on at least one metal oxide, preferably SiOx or aluminum oxide.

21. The multilayer film as claimed in any of claims 1-20, characterized in that the multilayer film comprises, as substrate layer, besides the layer sequence (a)-(c), at least one layer (e) based on at least one thermoplastic polymer, preferably selected from the group comprising polyolefins, polyamides, polyesters, polystyrenes, and copolymers of at least two monomers from the polymers mentioned, particularly preferably olefin homo- or copolymers and/or polyesters.

22. The multilayer film as claimed in any of claims 1-21, characterized in that the multilayer film has been printed, and/or colored, and/or embossed.

23. The multilayer film as claimed in any of claims 1-22, characterized in that the multilayer film has, on at least one of its surfaces, a release layer, preferably based on at least one hardened polysiloxane.

24. The multilayer film as claimed in any of claims 1-23, characterized in that the multilayer film has been equipped, on at least one of its surfaces, at least to some extent, with an adhesive layer.

25. The use of a multilayer film as claimed in any of claims 1-24 as packaging material.

26. The use of a multilayer film as claimed in any of claims 1-24 for the production of a packaging element and/or of packaging, preferably of bag packaging, of single-portion packaging, of a sachet, or of a stickpack.

27. The use of a multilayer film as claimed in claim 23 as release film.

28. An easy-to-open packaging or an easy-to-open packaging element, preferably a lid, made of the multilayer film as claimed in any of claims 1-24.

29. The packaging as claimed in claim 28 in the form of bag packaging, of single-portion packaging, of a sachet, or of a stickpack.
